(19) United States
(12) Patent Application Publication
(10) Pub. No.: US 2008/0294729 A1
(43) Pub. Date: Nov. 27, 2008

(54) EMAIL OBJECT FOR OPEN MOBILE ALLIANCE DATA SYNCHRONIZATION USAGE

(75) Inventors: Catalin Ionescu, Tampere (FI); Zoltan Ordogh, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/752,233

(22) Filed: May 22, 2007

(51) Int. Cl. G06F 15/16

(52) U.S. Cl. 709/206

(57) ABSTRACT

An email object is provided that fulfills requirements defined in the OMA MEM Enabler, where email messages are represented as extensible markup language documents. Filters created using XPath allow an email client to indicate what email messages are to be advertised as new and later downloaded. Table of content information can also be provided without the need for downloading an entire email object first, as well as additional information about each body part. Therefore, referencing body parts for downloading email body parts step-by-step or for use in a reply/forward without download use case, as well as allowing for the downloading of alternative content (e.g., content-adaptation) is provided. Data synchronization protocols are used to allow the email client to keep an equivalence relationship between main email storage on the email server and local mail storage on the email client side when transferring email messages between the email client and email server.

### FIELD OF THE INVENTION

The present invention relates generally to the field of client-server messaging. More particularly, the present invention relates to implementing mobile email messaging between a client and a server over a data synchronization protocol using an email object.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Email is conventionally thought of as a method of composing, sending, storing, and receiving messages made up of textual, visual, and/or other media-related components in an electronic format over the Internet. A primary use of email is to allow users to communicate with each other, and it may be noted that many experts tend to agree that email is the most-used application after the World Wide Web (WWW).

In generally, information flows as the content of email messages is exchanged between email clients via email servers. At its simplest, the email architecture is based on email clients communicating with email servers. The Internet Engineering Task Force (IETF) is a standards-based organization that develops and promotes Internet standards, as well as defines standards for email protocols. For example, Simple Mail Transfer Protocol (SMTP) defines a standard for sending emails whereas Internet Message Access Protocol (IMAP) and Post Office Protocol (POP) are standards for receiving emails. These specifications are the de facto standards of fixed Internet environments. In contrast, requirements identified for the mobile domain have yet to be satisfied through the use of these protocols.

The Open Mobile Alliance (OMA), a standards body that develops open standards for the mobile telephony industry, and its Mobile Email Working Group (MWG-MEM) have collected a set of use cases for email scenarios within the mobile environment. It is a goal of the OMA to optimize the use of email when a client is deployed in a mobile device. The initial assumption of OMA MEM (i.e., the mobile email enabler developed within OMA MWG-MEM group) is that the user experience when using a mobile device to access email should be very similar to accessing from and using email on a computer at the office or at the home, where the computer is connected to the fixed Internet environment. Therefore, the primary purpose of OMA MEM is to examine existing technologies for connecting mobile clients to email services, where the specifications should be defined and maintained in cooperation with the standardization bodies involved in defining the identified technologies.

Data Synchronization (DS) is another working group in OMA that focuses on developing specifications for data synchronization and other similar specifications, including but not limited to SyncML technology. These specifications include conformance specifications and a set of best practices that describe proper usage of the data synchronization technology specifications within the OMA Architecture.

The OMA MWG-MEM and OMA DS groups are currently working to define a technical specification for mobile email. In defining this technical specification, the use cases and requirements generated by MWG-MEM WG are taken into consideration by the DS working group in its future specification in order to create an alternative solution to the one offered by IETF-LEMONADE. In contrast to IETF-LEMONADE, OMA MWG-MEM and OMA DS groups contemplate transferring email messages to/from a client using the DS protocol instead of IETF protocols.

Although email messaging performed in accordance with the DS protocol is not a traditional method of performing email messaging, certain operators consider this approach to be the best solution for their use. Email messaging according to the DS protocol provides a robust and reliable synchronization mechanism across devices and interacts well considering the larger email messaging environment. That is, when OMA DS is deployed, calendar data and contacts are kept in sync, whereas IETF-LEMONADE provides no mechanism for such synchronization of data. Furthermore, in comparison to IETF-LEMONADE, which can only be deployed on top of previous IMAP solutions, OMA DS can be deployed on top of any email service.

The OMA DS working group has previously worked towards creating a solution for mobile email, where a specification defining an email object for OMA DS usage has been published as part of the OMA DS 1.2 specification. However, despite being a desirable start, the OMA DS 1.2 specification does not fulfill those expectations which the mobile telephony industry has defined in the OMA MEM Enabler. It should be noted, though, that DS is an evolving technology that can be utilized to perform email messaging in a convenient manner, thus prompting a clear need for further development thereof.

According to OMA MEM requirements, an email client needs to be able to access various and different parts of an email message separately. For example the email client needs to be able to download only the headers of the email message as a first step. The user can then decide to open an email message based on envelope information. The textual portion of the email message can then be downloaded and presented for reading, display, etc. Furthermore, based on the user's decision, one or all of the remaining parts (e.g., attachments to the email message) can be downloaded. Therefore, given this example, it can be understood that a major requirement of a protocol used by a mobile email client in order to communicate with the email server is to convey the email message structure and allow the retrieval of individual parts of that structure.

As noted above, the requirements for mobile email according to OMA MEM requirements are derived from of use cases. Several “main” use cases for mobile email are described hereafter. A partial download use case involves notifying an email user of a new email message, where during a first stage, the envelope information of the email message is downloaded so that the email client user interface (UI) can be presented to the user. At the user's request, the text portion of the email message body is downloaded along with the type of the attachment(s) if any are found therein. Therefore, at this stage, the user is aware of the number of attachments that are contained within the email message body, and can decide to download some of those attachments. A reply/forward without downloading use case also involves notifying an email user of a new message. In a first stage, the envelope information is downloaded so that the email client UI can be presented to the user, as in the partial download use case. At this stage, the user has enough information to reply to or forward the email message, and the email client UI will allow the user to create a message that can later be combined with a corresponding email message on a server in order to be delivered for submission. Lastly, a use case for downloading an attachment in a format that can be handled by the mobile device is considered. In this use case, mobile devices lack processing power, where certain attachments received as one or more parts of an email message cannot be properly handed. Therefore, a need exists for the ability to request that the server convert those certain attachments into a format that can be handled by the mobile device/email client.

According to the OMA DS 1.2 specification, an email object is defined in order to allow a DS client to send and receive email messages using the DS protocol. The email objects are represented in extensible markup language (XML) and the content-specific aspects of synchronization are defined and clarified. The current content model describes the email object as a collection of carefully selected elements from RFC 2822, e.g., read, forwarded, replied, received, created, modified, deleted, flagged, and the email body. Therefore, the OMA DS email object does not cover the entire RFC 2822 email envelope definition. The actual structure of the message is not conveyed to the email client either.

The OMA DS specification also allows an email client to split an email message into the following parts: headers; a text part; and an attachments part. Additionally, filters have been defined for the downloading of headers, text, or attachments. Most requirements identified by OMA MEM rely on the granularity offered by an email object as defined in RFC 2822, which can be found at http://www.ietf.org/rfc/rfc2822.txt. However, the current OMA DS email specification fails to offer the same granularity when using its XML representation of the email object, and this level of granularity fails to fulfill the OMA MEM requirements, which are described in greater detail below.

The structure of a OMA DS 1.2 email object is comprised of headers, a text body part, and an attachment body part in accordance with the OMA DS 1.2 specification described above. It should be noted however, that in a OMA DS 1.2 email object, the headers can only be accessed as a whole. There is no mechanism for only downloading specific headers. In practice, this results in the downloading of all the headers of an email message instead of downloading only those headers that convey the envelope information that the email client needs to download. In addition, it is not currently possible to only download that information which is needed for a mailbox view in the UI.

With regard to the text part of an email message, the whole text part or certain portions of the text part can be downloaded. The portions can be specified by either providing a content type (only the text/plain is downloaded) or by providing the size of that particular part that is to be downloaded. However, a problem exists when utilizing these methods of partial downloading because in order to download the text part of an email message, the headers need to be downloaded as well. Therefore, a mobile email client that wants to fulfill the requirements set by OMA MEM will end up downloading the headers several times, thus generating undesired traffic usage. The attachment part of an email message can also be downloaded as a whole or in parts. As with the downloading of a text part, a content type, a size, or both can be specified as part of a filtering rule configured to download the email message.

The following description indicates some of those identified requirements that are not fulfilled by the OMA DS email specification, including those discussed above: it needs to be possible to download only certain headers; it needs to be possible to download only the text part of an email message; it needs to be possible to identify the attachment in an email message; it needs to be possible to download the attachments of an email message one by one; it needs to be possible to download only a certain part of an email message(as opposed to the OMA DS specification, where the headers are always downloaded regardless of whether another part is to be downloaded; it needs to be possible to forward an email message without downloading and uploading the entire email message; and it should be possible to perform content adaptation upon a client's request.

With regard to traditional email messaging methods, the Email Data Model defined in RFC 2822 describes an email envelope as a collection of US American Standard Code for information exchange (US-ASCII) characters organized in lines and split into two parts. The header fields (collectively referred to as “the header of the message”) are comprised of a sequence of lines of characters with a special syntax, as defined by the RFC 2822 standard. The header is followed optionally by a body, where the body is a sequence of characters separated from the header by an empty line (i.e., a line with nothing preceding the carriage return/line feed (CRLF) character).

Many different standards define the way in which the header and the body are structured, one of which is the Multipurpose Internet Mail Extension (MIME) set of specifications. The structure introduced by the MIME specifications for email messages is used by email protocols in order to allow for the inclusion of various media types (besides plain text) in email messages, where interoperability can be effectuated. In practice, the MIME structure can allow an email messaging protocol to selectively download parts of an email message like a reader can selectively read particular chapters in a book.

FIG. 1 illustrates an example of an email message that has a header and body structure according to the MIME specifications. The header is comprised of at least a source portion 100, a destination portion 110, a subject portion 120, and various other header portions 130. The body is comprised of at least a text part 140, one image attachment 150, and one sound clip attachment 160.

As described above, certain attempts have been made to address all mobile email problems, where some solutions exist for some of these problems or parts of these problems. However, as discussed above, current specifications and standards, such as the OMA DS 1.2 specification, do not fulfill all of the mobile email requirements required in OMA MEM so that a user's mobile emailing experience is substantially the same as the user's fixed-Internet emailing experience.

### SUMMARY

Various embodiments define an email object that fulfills the requirements defined in the OMA MEM Enabler, where email messages can be represented as extensible markup language (XML) documents. Additionally, XPath grammar is utilized to create filters that allow an email client to indicate to an email server, what email messages are to be advertised as being new and downloaded at a later time. Furthermore, various embodiments provide table of content (TOC) information without the need for downloading an entire email object first, and provide additional information about each body part as well. Therefore, referencing body parts for downloading email body parts step-by-step or for use in a reply/forward without download use case, as well as allowing for the downloading of alternative content (e.g., content-adaptation) is provided.

Moreover, DS protocols are used in order to allow the email client to keep an equivalence relationship between a main email storage on the email server and a local mail storage on the email client side. The DS email clients and servers can send changes to the equivalence relationship in both directions, while the email server can send any new information which has arrived at the email boxes, and the email client can send any modifications performed locally to the email server. As such, the various embodiments provide interoperable OMA DS email implementations that can be integrated into an OMA standard, which result in better coverage of the OMA MEM requirements.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 illustrates a traditional email message structure according to MIME specifications;

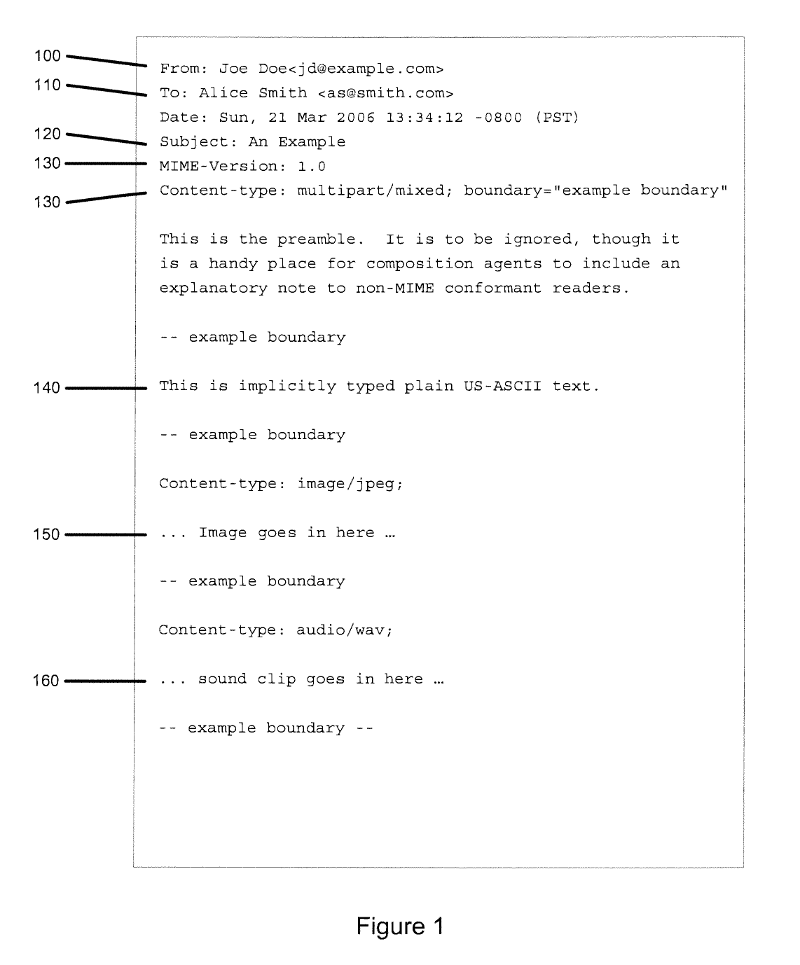

FIG. 2 shows an exemplary synchronization operation in accordance with various embodiments;

FIG. 3 is an overview diagram of a mobile email messaging architecture within which various embodiments may be implemented;

FIG. 4 is a flow chart illustrating data synchronization processes executed in accordance with various embodiments;

FIG. 5 is an overview diagram of a system within which various embodiments may be implemented;

FIG. 6 is a perspective view of a mobile telephone that can be used in the implementation of various embodiments; and

FIG. 7 is a schematic representation of the telephone circuitry of the mobile telephone of FIG. 6;

### DETAILED DESCRIPTION OF VARIOUS EMBODIMENTS

As described above, the main use cases identified by OMA MEM for mobile email messaging are partial download, reply/forward without downloading; and downloading an attachment in a format that can be handled by the mobile device. Also as described above, most of the requirements identified by OMA MEM rely on the granularity offered by the email object as defined in RFC 2822.

Various embodiments provide an XML format that will provide for the same granularity offered by the model defined by RFC 2822, including support for all RFC 2822 and optional (extension) header fields and flags. Additionally, various embodiments provide TOC information without the need for downloading an entire email object first, and provide additional information about each body part as well. Furthermore, various embodiments allow referencing body parts for downloading email body parts step-by-step or for use in reply/forward without download use case, and allow downloading alternative content (e.g., content-adaptation) from a client perspective. From a server perspective, various embodiments provide the same features as described above, but for transmitting the body parts, reply/forward emails, and alternative content to the client.

XML has the ability to support almost any information in any written language to be communicated, where the structure and field names, as well as specific values of an XML document and/or information contained therein are described in the XML document itself. Therefore, this self-describing/self-documenting nature of XML is used in order to consider the content-specific aspects of synchronization. Furthermore, utilizing XPath grammar in conjunction with an XML document makes it possible to refer to individual parts of the XML document, thus providing random access to XML data for other technologies. Moreover, XPath expressions can refer to all or part of the text, data and values in XML elements, attributes, processing instructions, comments etc., and can access the names of elements and attributes. Therefore, Xpath grammar can be used to apply record and field-level filtering, which allows an OMA DS email client to access specific parts of an email message without having to download the same data more than once. It should be noted that although the description of various embodiments herein refer to email messaging technology, the various embodiments are applicable to any other messaging system that intends to use a DS protocol to transfer messages between a client and a server.

The XML document type definition (DTD) utilized to describe the OMA DS email object is given as follows:

```
<!--
OMA MEM DS Email Object 1.0 Document Type Definition
<?xml version=“1.0”?>
  <!DOCTYPE OMAMEM-DS PUBLIC “-//OMA//DTD
  OMAMEM-DS 1.0//EN”
      “http://www.openmobilealliance.org/tech/DTD/OMAMEM-
      DSEMAIL.DTD”
      [<?oma-mem-ds-ver supported-versions=“1.0”?>]>
  <OMA-MEM-DS-EmailObject
xmlns=“http://www.openmobilealliance.org/DTD/OMAMEM-DS1.0”>
      ......
  </OMA-MEM-DS-EmailObject>
```

Terms and conditions of use are available from the
Open Mobile Alliance Ltd. web site at
http://www.openmobilealliance.org/UseAgreement.html

```
-->
<?xml version=“1.0” encoding=“UTF-8”?>
<!-- DS Email Object Definition-->
<!ELEMENT OMA-MEM-DS-EmailObject (
  HEADER,
  TOC?,
  BODY?,
  ExtensionBlock?
  )>
<!ATTLIST OMA-MEM-DS-EmailObject xmlns CDATA #REQUIRED>
<!-- Header definition -->
<!ELEMENT HEADER (
  OriginatorFields?,
  DestinationFields?,
  IdentificationFields?,
  InformationFields?,
  ResentFields?,
  TraceFields?,
  OptionalFields?,
  IMAPFlags*,
  TotalSize,
  ExtensionBlock?
  )>
<!-- Table of contents definition -->
<!ELEMENT TOC (
  BodyPartDescription*,
  ExtensionBlock?
  )>
<!-- Bodypart definition -->
<!ELEMENT BODY (
  BodyPart+,
  ExtensionBlock?
  )>
<!-- Header structure definitions -->
```

<!-- RFC2822::3.6.1 and 3.6.2 -->

```
<!ELEMENT OriginatorFields (
  HeaderField+
  )>
```

<!-- RFC2822::3.6.3 -->

```
<!ELEMENT DestinationFields (
  HeaderField+
  )>
```

<!-- RFC2822::3.6.4 -->

```
<!ELEMENT IdentificationFields (
  HeaderField+
  )>
<!ELEMENT References (
  HeaderField+
  )>
```

<!-- RFC2822::3.6.5 -->

```
<!ELEMENT InformationFields (
  HeaderField+
  )>
```

<!-- RFC2822::3.6.6 -->

```
<!ELEMENT ResentFields (
  HeaderField+
  )>
```

<!-- RFC2822::3.6.7 -->

```
<!ELEMENT TraceFields (
  HeaderField+
  )>
```

<!-- RFC2822::3.6.8 -->

```
<!ELEMENT OptionalFields (
  HeaderField+
  )>
<!ELEMENT IMAPFlags (
  IMAPFlag+
  )>
<!ATTLIST IMAPFlags
  scope (Permanent | SessionOnly) #REQUIRED
  >
<!-- Header terminating element definitions -->
```

| | |
|---|---|
| <!ELEMENT TotalSize (#PCDATA)> | <!-- Size of the whole message in |
| octets when transfer encoded --> | |

| | |
|---|---|
| <!ELEMENT MessageID (#PCDATA)> | <!-- RFC2822::message-id --> |

| | |
|---|---|
| <!ELEMENT HeaderField (#PCDATA)> | <!-- RFC2822::fields --> |
| <!ELEMENT IMAPFlag (#PCDATA)> | <!-- RFC3501::2.3.2 --> |

```
<!-- Table of contents structure definitions -->
<!ELEMENT BodyPartDescription (
  ReferenceID?,
  MIMEFields,
  IsProtected,
  Alternatives?,
  BodyPartDescription*,
  ExtensionBlock?
  )>
<!ELEMENT MIMEFields (
  Name?,
  Type,
  SubType,
  Parameters?,
  Language?,
  Encoding?,
  Size?,
  MD5Checksum?,
  ExtensionBlock?
  )>
<!ELEMENT Alternatives (
  Alternative+
  ExtensionBlock?
  )>
<!ELEMENT Alternative (
  ReferenceID,
  MIMEFields,
  ExtensionBlock?
  )>
<!ELEMENT Parameters (
  Parameter+
  )>
<!-- Table of contents terminating element definitions -->
```

| | |
|---|---|
| <!ELEMENT ReferenceID (#PCDATA)> | <!-- Unique ID assigned by the |
| server --> | |
| <!ELEMENT IsProtected (#PCDATA)> | <!-- Is it protected by some DRM |
| solution? --> | |

| | |
|---|---|
| <!ELEMENT Name (#PCDATA)> | <!-- Description of an object (e.g. |
| filename) --> | |
| <!ELEMENT Type (#PCDATA)> | <!-- Content media type name, see |
| [RFC2045] --> | |

| | |
|---|---|
| <!ELEMENT SubType (#PCDATA)> | <!-- Content media subtype name, |
| see [RFC2045] --> | |
| <!ELEMENT Parameter (#PCDATA)> | <!-- Attribute/value pairs, see |
| [RFC2045] (e.g. charset) --> | |
| <!ELEMENT Language (#PCDATA)> | <!-- Body language value, see |
| [BCP47] and [RFC 3066], --> | |
| <!ELEMENT Encoding (#PCDATA)> | <!-- Content transfer encoding, see |
| [RFC2045] --> | |

| | |
|---|---|
| <!ELEMENT Size (#PCDATA)> | <!-- Size of the body in octets when |
| transfer encoded --> | |

| | |
|---|---|
| <!ELEMENT MD5Checksum (#PCDATA)> | <!-- MD5 checksum of the |
| bodypart, see [RFC1864] --> | |
| <!-- Bodypart structure definitions --> | |
| <!ELEMENT BodyPart ( | |
| ReferenceID?, | |
| Data, | |
| ExtensionBlock? | |
| )> | |
| <!-- Bodypart terminating element definitions --> | |

| | |
|---|---|
| <!ELEMENT SequenceID (#PCDATA)> | <!-- Unique ID, integer |
| from 0 to n --> | |

| | |
|---|---|
| <!ELEMENT Data (#PCDATA)> | <!-- Actual data of the body --> |
| <!-- General purpose definitions --> | |

| | |
|---|---|
| <!ELEMENT ExtensionBlock (#PCDATA)> | <!-- This allows |
| custom extensions --> | |

| | |
|---|---|
| <!ATTLIST ExtensionBlock xmlns CDATA #REQUIRED> | <!-- Custom |
| extensions need to provide namespace --> | |

Furthermore, an example of an OMA DS email object is given below. It should be noted that for demonstration purposes, the email object shown below contains all of the different types of fields to illustrate an entire email structure. Therefore, the values included in the example email object are not necessarily valid or real. In addition, CRLF characters have been omitted in the interest of saving space.

```
<OMA-MEM-DS-EmailObject
xmlns=“http://www.openmobilealliance.org/DTD/OMAMEM-DS1.0”>
    <HEADER>
      <OriginatorFields>
        <HeaderField>Date: Thu, 6 May 2006 14:00:00 -
0200</HeaderField>
        <HeaderField>From: “John”
&lt;john@foo.org&gt;</HeaderField>
        <HeaderField>Sender: “Secretary”
&lt;secretary@foo.org&gt;</HeaderField>
        <HeaderField>Reply-To: “Secretary”
&lt;secretary@foo.org&gt;</HeaderField>
      </OriginatorFields>
      <DestinationFields>
        <HeaderField>To: “John” &lt;john@foo.org&gt;, “Mike”
&lt;mike@foo.org&gt;</HeaderField>
        <HeaderField>CC: “Monica”
&lt;monica@foo.org&gt;</HeaderField>
        <HeaderField>BCC: “Archive”
&lt;archive@foo.org&gt;</HeaderField>
      </DestinationFields>
      <IdentificationFields>
        <HeaderField>Message-ID:
&lt;11111.11111.DSMailSYSTEM@foo&gt;</HeaderField>
        <HeaderField>In-Reply-To:
&lt;22222.22222.DSMailSYSTEM@foo&gt;</HeaderField>
        <HeaderField>References:
&lt;33333.33333.DSMailSYSTEM@foo&gt;</HeaderField>
        <HeaderField>In-Forward-To:
&lt;11111.11111.DSMailSYSTEM@foo&gt;</HeaderField>
      </IdentificationFields>
      <InformationFields>
        <HeaderField>Subject: Meeting tomorrow</HeaderField>
        <HeaderField>Comments: Authenticated sender is
&lt;secretary@foo.org&gt;</HeaderField>
        <HeaderField>Keywords: meeting, customer, product,
development</HeaderField>
      </InformationFields>
      <ResentFields>
        <HeaderField>Resent-Date: Thu, 6 May 2006 14:00:00 -
0200</HeaderField>
        <HeaderField>Resent-From: “John”
&lt;john@foo.org&gt;</HeaderField>
        <HeaderField>Resent-Sender: “Secretary”
&lt;secretary@foo.org&gt;</HeaderField>
        <HeaderField>Resent-To: “John” &lt;john@foo.org&gt;, “Mike”
&lt;mike@foo.org&gt;</HeaderField>
        <HeaderField>Resent-Cc: “Monica”
&lt;monica@foo.org&gt;</HeaderField>
        <HeaderField>Resent-Bcc: “Archive”
&lt;archive@foo.org&gt;</HeaderField>
        <HeaderField>Resent-Message-ID:
&lt;11111.11111.DSMailSYSTEM@foo&gt;</HeaderField>
      </ResentFields>
      <TraceFields>
        <HeaderField>Return-Path:
&lt;secretary@foo.org&gt;</HeaderField>
        <HeaderField>Received: from mail.foo.org (mail.foo.org
[127.0.0.1]) by mail2.foo.org (8.11.1/8.11.1) with ESMTP id f22K5xv12202 for
&lt;secretary@foo.org&gt; Thu, 6 May 2006 14:00:02 -0200 (EST)</HeaderField>
        <HeaderField>Received: from mail2.foo.org (mail2.foo.org
[127.0.0.2]) by mail3.foo.org (F-8_9_3_3/8.9.3) with SMTP id MAA14914 for
&lt;secretary@foo.org&gt; Thu, 6 May 2006 14:00:01 -0200 (EST)</HeaderField>
      </TraceFields>
      <OptionalFields>
        <HeaderField>Auto-Forwarded:</HeaderField>
        <HeaderField>Content-Language: en</HeaderField>
        <HeaderField>Importance: high</HeaderField>
        <HeaderField>Errors-To:
&lt;admin@foo.org&gt;</HeaderField>
        <HeaderField>MIME-Version: 1.0</HeaderField>
        <HeaderField>Sensitivity: company confidential</HeaderField>
        <HeaderField>X-Confirm-Reading-To:
&lt;secretary@foo.org&gt;</HeaderField>
        <HeaderField>X-Mailer: DSMail 1.0</HeaderField>
      </OptionalFields>
      <IMAPFlags scope=“Permanent”>
        <IMAPFlag>\Deleted</IMAPFlag>
        <IMAPFlag>\Draft</IMAPFlag>
      </IMAPFlags>
      <IMAPFlags scope=“SessionOnly”>
        <IMAPFlag>\Seen</IMAPFlag>
        <IMAPFlag>\Answered</IMAPFlag>
      </IMAPFlags>
      <TotalSize>20000</TotalSize>
    </HEADER>
    <TOC>
      <BodyPartDescription>
    <ReferenceID>DS_0xABCDEF00@mail.foo.org_&lt;11111.11111.DSMailSYSTEM@foo&gt;
</ReferenceID>
        <MIMEFields>
          <Type>multipart</Type>
          <SubType>mixed</SubType>
          <Encoding>base64</Encoding>
          <Size>20000</Size>
    <MD5Checksum>a7daae3e19d54cc5c60bbc6d9c95e76b</MD5Checksum>
        </MIMEFields>
        <IsProtected>F</IsProtected>
        <BodyPartDescription>
    <ReferenceID>DS_0xABCDEF01@mail.foo.org_&lt;11111.11111.DSMailSYSTEM@foo&gt;
</ReferenceID>
          <MIMEFields>
            <Type>text</Type>
            <SubType>html</SubType>
            <Parameters>
              <Parameter>charset=UTF-8</Parameter>
            </Parameters>
            <Encoding>base64</Encoding>
            <Size>4000</Size>
    <MD5Checksum>d0aaae16ba162dd89d646887f1539855</MD5Checksum>
          </MIMEFields>
          <IsProtected>F</IsProtected>
          <Alternatives>
            <Alternative>
              <ReferenceID>
    DS_0xABCDEF01_A1@mail.foo.org_&lt;11111.11111.DSMailSYSTEM@foo&gt;
              </ReferenceID>
              <MIMEFields>
                <Type>text</Type>
                <SubType>plain</SubType>
                <Parameters>
                  <Parameter>charset=iso-
8859-1</Parameter>
                </Parameters>
              </MIMEFields>
            </Alternative>
          </Alternatives>
      </BodyPartDescription>
      <BodyPartDescription>
    <ReferenceID>DS_0xABCDEF02@mail.foo.org_&lt;11111.11111.DSMailSYSTEM@foo&gt;
</ReferenceID>
          <MIMEFields>
    <Name>ArchitectureDrawing20060509.jpg</Name>
            <Type>image</Type>
            <SubType>jpeg</SubType>
            <Parameters>
              <Parameter>charset=UTF-8</Parameter>
            </Parameters>
            <Encoding>base64</Encoding>
            <Size>16000</Size>
    <MD5Checksum>d0aaae16ba162dd89d646887f1539855</MD5Checksum>
          </MIMEFields>
          <IsProtected>T</IsProtected>
        </BodyPartDescription>
      </BodyPartDescription>
    </TOC>
    <BODY>
      <BodyPart>
        <SequenceID>0</SequenceID>
        <Data>BASE64EncodedDataHere:OriginalMail</Data>
      </BodyPart>
      <BodyPart>
        <SequenceID>1</SequenceID>
        <Data>BASE64EncodedDataHere:MailPart1</Data>
      </BodyPart>
      <BodyPart>
        <SequenceID>2</SequenceID>
        <Data>We have a customer meeting, more blabla up to 1500
bytes</Data>
      </BodyPart>
      <BodyPart>
        <SequenceID>3</SequenceID>
        <Data>BASE64EncodedDataHere:MailPart3</Data>
      </BodyPart>
    </BODY>
</OMA-MEM-DS-EmailObject>
```

The OMA DS specification defines a standard to establish and maintain an equivalence relationship between two sets of data. In the case of email messaging, the DS protocols are used in order to allow an email client to keep the equivalence relationship between a main email storage on an email server and a local mail storage on the email client side. The DS email clients and servers can send changes to the equivalence relationship in both directions. The email server can send any new information which has arrived at the email boxes, while the email client can send any modifications performed locally to the email server. Such modifications include, but are not limited to new email submission (e,g, new, reply or forward), email deletion (e.g., soft or hard delete), and email modifications (e.g., saving email at the main email storage).

A standard sequence assumes that the DS client starts the synchronization, although the DS server is provided with a mechanism for requesting that the DS client starts a synchronization session. During a synchronization session, the DS client will send its modifications, and the DS server will process those modifications and send its own set of modifications to the DS client. Both the DS server and the DS client can maintain their own mapping tables, although the master mapping table is located at the DS server. Additionally, the DS client is able to choose whether or not to maintain its own mapping table based upon its own needs. After the modifications are sent from the DS client to the DS server and from the DS server to the DS client, respectively, the mapping tables at both the DS client and the DS server are synchronized. Furthermore, the actual synchronization operation is based on filters, where a filter query is a logical expression applied to each item in a recipient's data store. Items for which the expression evaluates to “true” are the set of items that will be included for that synchronization session. It should be noted that the filter query is expressed according to a particular grammar, including but not limited to the XPath grammar described above.

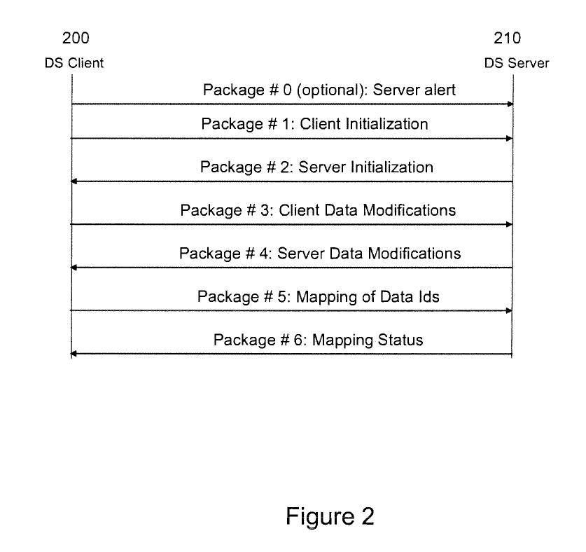

FIG. 2 shows a synchronization operation in accordance with various embodiments. OMA DS defines a synchronization session in terms of Packages, where each Package contains a logical set of commands and responses. In practice, a Package can consist of a number of physical messages. As shown in FIG. 2, an optional server alert message, Package #0, and a client initialization message, Package #1, are sent from the DS client 200 to the DS server 210. The DS server 210 responds with a server initialization message, Package #2, that is sent to the DS client 200. As described above, the DS client 200 sends its client data modifications to the DS server 210 in Package #3, after which the DS server 210 sends its own server data modifications to the DS client 200 in Package #4. Thereafter, the respective mapping tables of the DS client 200 and the DS server 210 are synchronized, which can be accomplished by the DS client 200 sending a mapping of data IDs message, Package #5, and the DS server 210 responding with a mapping status message, Package #6. The process of mapping data IDs is executed because IDs for data items can be different between the DS server's own mapping table and the DS client's own mapping table as described above. Therefore, the master mapping table of the DS server can be used to determine which DS client ID and which DS server ID point to the same data item.

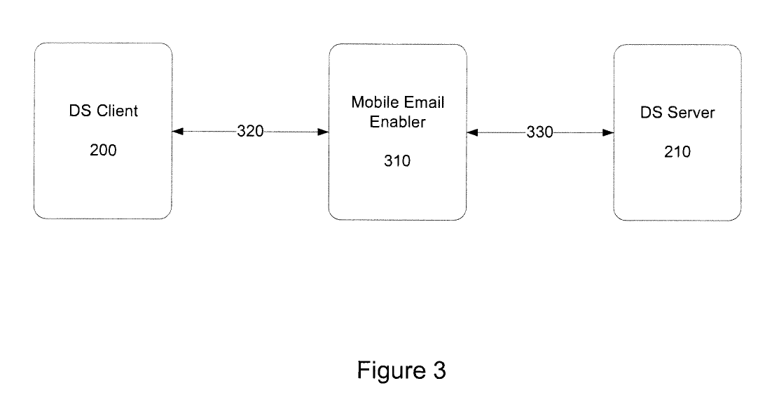

FIG. 3 shows a system illustrating the connectivity between the DS Client 200 and the DS Server 210 in an OMA architecture. The DS Client 200 communicates with a Mobile Email Enabler 310 over a mobile email protocol 320, such as the DS-based protocols described above. In turn, the Mobile Email Enabler 310 and the DS Server 210 communicate using a server email protocol 330. It should be noted that various server email protocols can be utilized within the OMA architecture of FIG. 3.

It should also be noted that two levels of filtering are applied in accordance with various embodiments, i.e., a record level filtering and a field level filtering. Using record level filters, a client can request certain records to be synchronized, where the actual content of the records to be synchronized is described using field level filters. In other words, field level filtering applies to fields or properties within the records, and provides the ability to omit fields or truncate fields during a synchronization session. It should be noted that omitted or truncated fields can be retrieved at a later time. For example, record level filtering can be used to download all emails received after a certain date and time, whereas field level filtering can be used to download only the header fields of those emails received after the particular date and time.

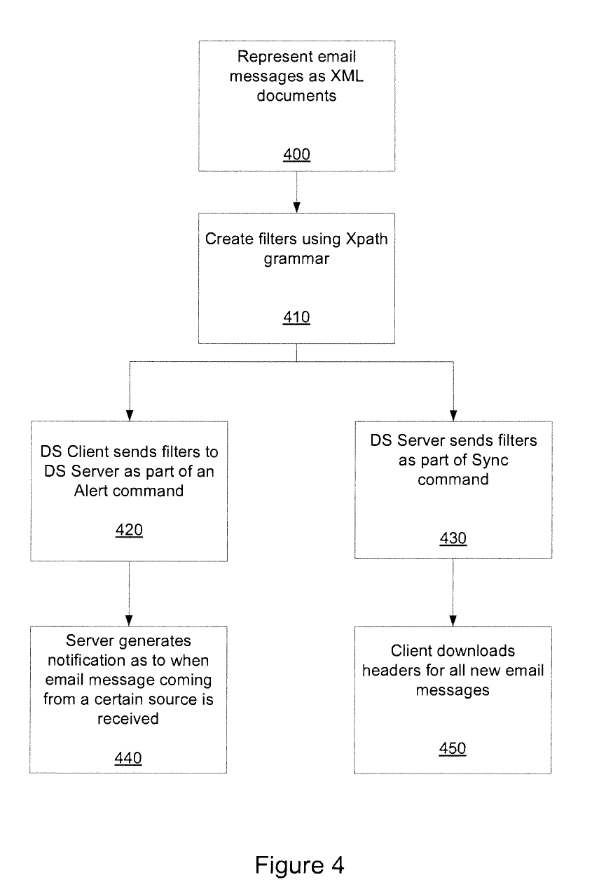

The OMA DS email implementation is be based on the DTD defined above, where as illustrated in FIG. 4, email messages on the DS server are represented as XML documents conformant to the DTD at 400. XPath grammar is used for creating filters at 410, e.g., the record level filters and the field level filters, in order to allow the DS client to tell the server what emails are to be advertised as new and downloaded at a later time. Filtering can comprise utilizing those filters that allow the DS server to decide what changes to the data source trigger and alert should result in the generation of a notification. These filters are sent by the DS client as part of an Alert command at 420. Filters that are sent at 430 as part of Sync command enable the DS client to decide what emails are to be downloaded. Therefore, an Alert filter can tell the DS server to generate a notification at 440 when an email coming from a certain source is received at the DS server, and a Sync filter allows the DS client to download one or more desired parts, e.g., the headers, for all the new emails at 450.

As described herein, various embodiments provide interoperable OMA DS email implementations that fulfill the requirements set by the OMA MEM working group and can be integrated into an OMA standard. Therefore, better coverage of the OMA MEM requirements are achieved than with the OMA DS 1.2 email object. That is, at least the following identified requirements can be met by various embodiments: the ability to download only certain headers; the ability to download only the text part of an email message; the ability to identify the attachment in an email message; the ability to download the attachments of an email message singularly (e.g., one by one); the ability to download only a certain part of an email message(as opposed to the OMA DS specification, where the headers are always downloaded regardless of whether another part is to be downloaded; the ability to forward an email message without downloading and uploading the entire email message; and the ability to perform content adaptation upon a client's request. In addition, the same logic can be applied to any other messaging system where message object transfer using DS is desired. It should be noted that although a TOC might grow large given the amount of possibilities for indicating different parts of email message, using Binary XML representation can reduce the size of the TOC significantly.

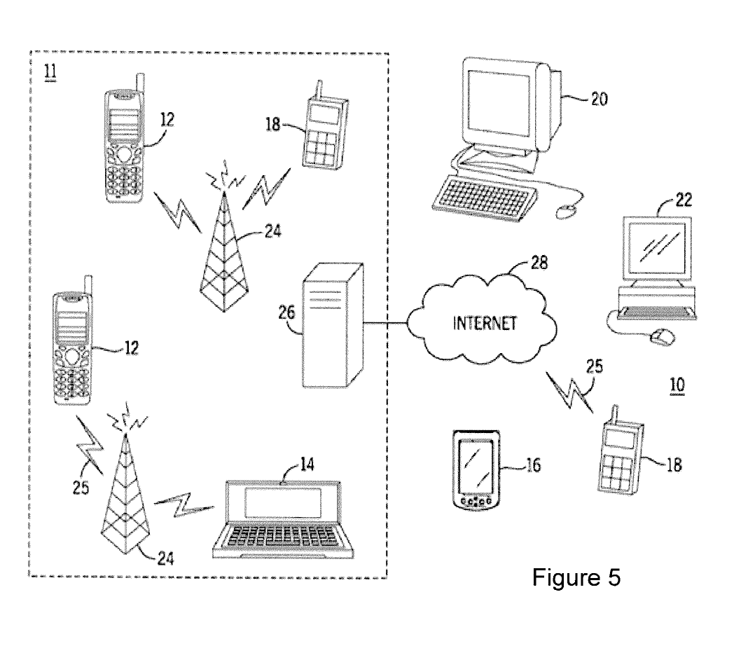

FIG. 5 shows a more comprehensive view of a system 10 in which the various embodiments can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile telephone network 11 and the Internet 28 over which, email messaging can be effectuated as described above. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

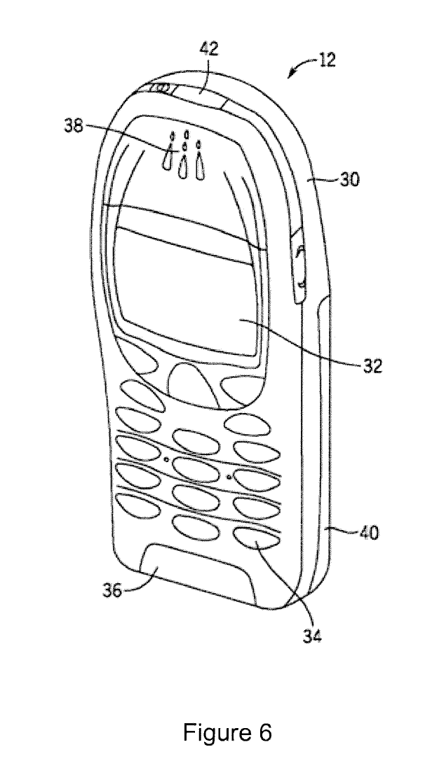

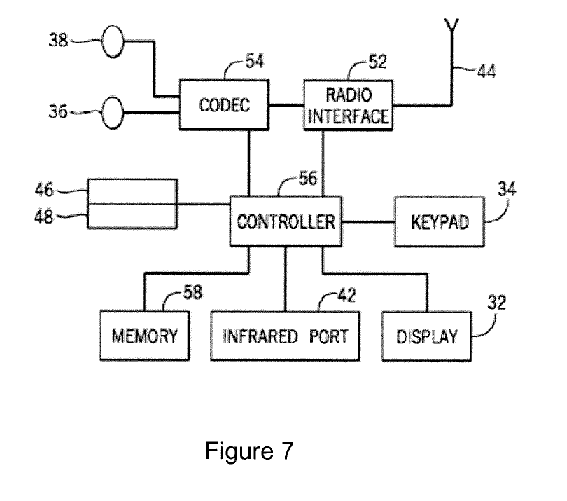

FIGS. 6 and 7 show one representative mobile device 12 within which the various embodiments may be implemented. It should be understood, however, that the various embodiments are not intended to be limited to one particular type of electronic device. The mobile device 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of transferring a message to and from a client using a data synchronization protocol, comprising:
transmitting a first data modification and receiving a second data modification; and
synchronizing the message in accordance with at least one of the first and second data modifications, the message being represented as an extensible markup language document conformant to an object, wherein the synchronizing includes at least one of the group including downloading only at least one of a plurality of particular headers of the message, downloading only a text part of the message, downloading attachment parts of the message singularly, identifying at least one attachment part of the message, downloading one of the text part and the at least one attachment part of the message without downloading any headers, forwarding the message without downloading and uploading the message in its entirety, and performing content adaptation of at least one alternative part of the message upon request by the client.

2. The method of claim 1, wherein the synchronization of the message is performed pursuant to a request by the client to synchronize only the message, wherein the message is at least one of stored and received with a plurality of other messages and the request is effectuated using a record level filter.

3. The method of claim 2, wherein the record level filter is created using XPath grammar.

4. The method of claim 2, wherein the record level filter is sent from the client to a server as part of an alert command indicating that the server is to generate a notification when a message coming from a particular source is received at the server.

5. The method of claim 1, wherein content of the message to be synchronized is described using a field level filter.

6. The method of claim 5, wherein the field level filter is created using XPath grammar.

7. The method of claim 5, wherein the field level filter is sent from a server to the client as part of a sync command enabling the client to decide that the message, among a plurality of other messages, is to be downloaded.

8. The method of claim 1, wherein the message is an email message.

9. The method of claim 1, wherein the first modification data is associated with locally performed modifications at the client including at least one of a new message, a reply message, and a forward message, a soft message deletion, a hard message deletion, and saving the message at a main message storage, wherein the main message storage is located remotely at a server.

10. The method of claim 1, wherein the second modification data is associated with new information received at a server operatively connected to the client.

11. The method of claim 10, wherein the client and the server maintain respective mapping tables, the mapping tables being utilized for the synchronizing of the message.

12. A computer program product, embodied on a computer-readable medium, configured to perform the processes of claim 1.

13. A client apparatus, comprising:
a processor; and
a memory unit operatively connected to the processor and including:
computer code configured to transmit a first data modification and receive a second data modification in accordance with transferring a message to and from the client using a data synchronization protocol; and
computer code configured to synchronize the message in accordance with at least one of the first and second data modifications, the message being represented as an extensible markup language document conformant to an object, wherein the synchronizing includes at least one of the group including downloading only at least one of a plurality of particular headers of the message, downloading only a text part of the message, downloading attachment parts of the message singularly, identifying at least one attachment part of the message, downloading one of the text part and the at least one attachment part of the message without downloading any headers, forwarding the message without downloading and uploading the message in its entirety, and performing content adaptation of at least one alternative part of the message upon request by the client.

14. The client apparatus of claim 13, wherein the memory unit further comprises computer code configured to perform the synchronization of the message pursuant to a request by the client to synchronize only the message, wherein the message is at least one of stored and received with a plurality of other messages and the request is effectuated using a record level filter.

15. The client apparatus of claim 13, wherein the message is an email message.

16. The client apparatus of claim 13, wherein the first modification data is associated with locally performed modifications at the client including at least one of a new message, a reply message, and a forward message, a soft message deletion, a hard message deletion, and saving the message at a main message storage, wherein the main message storage is located remotely at a server.

17. The client apparatus of claim 13, wherein the second modification data is associated with new information received at a server operatively connected to the client.

18. A method of transferring a message to and from a server using a data synchronization protocol, comprising:
receiving a first data modification and transmitting a second data modification; and
synchronizing the message in accordance with at least one of the first and second data modifications, the message being represented as an extensible markup language document conformant to an object, wherein the synchronizing includes at least one of the group including transmitting only at least one of a plurality of particular headers of the message, transmitting only a text part of the message, transmitting attachment parts of the message singularly, identifying at least one attachment part of the message, transmitting one of the text part and the at least one attachment part of the message without transmitting any headers, receiving the message for forwarding without downloading and uploading the message in its entirety, and effectuating content adaptation of at least one alternative part of the message.

19. The method of claim 18, wherein the synchronization of the message is performed pursuant to a request sent by a client to the server to synchronize only the message, wherein the message is at least one of stored and received with a plurality of other messages and the request is effectuated using a record level filter.

20. The method of claim 19, wherein the record level filter is created using XPath grammar.

21. The method of claim 19, wherein the record level filter is sent from the client to the server as part of an alert command indicating that the server is to generate a notification when a message coming from a particular source is received at the server.

22. The method of claim 18, wherein content of the message to be synchronized is described using a field level filter.

23. The method of claim 22, wherein the field level filter is created using XPath grammar.

24. The method of claim 22, wherein the field level filter is sent from the server to a client as part of a sync command enabling the client to decide that the message, among a plurality of other messages, is to be downloaded.

25. The method of claim 18, wherein the message is an email message.

26. The method of claim 18, wherein the first modification data is associated with locally performed modifications at a client, operatively connected to the server, including at least one of a new message, a reply message, and a forward message, a soft message deletion, a hard message deletion, and saving the message at a main message storage located at the server.

27. The method of claim 18, wherein the second modification data is associated with new information received at the server.

28. The method of claim 27, wherein the client maintains a first local mapping table and the server maintains a second mapping table and a master mapping table, the first and second local mapping tables and the master mapping table being utilized for the synchronizing of the message.

29. A computer program product, embodied on a computer-readable medium, configured to perform the processes of claim 18.

30. A server apparatus, comprising:
a processor; and
a memory unit operatively connected to the processor and including:
computer code configured to receive a first data modification and transmit a second data modification in accordance with transferring a message to and from the server using a data synchronization protocol; and
computer code configured to synchronize the message in accordance with at least one of the first and second data modifications, the message being represented as an extensible markup language document conformant to an object, wherein the synchronizing includes at least one of the group including transmitting only at least one of a plurality of particular headers of the message, transmitting only a text part of the message, transmitting attachment parts of the message singularly, identifying at least one attachment part of the message, transmitting one of the text part and the at least one attachment part of the message without transmitting any headers, receiving the message for forwarding without downloading and uploading the message in its entirety, and effectuating content adaptation of at least one alternative part of the message.

31. The server apparatus of claim 30, wherein the memory unit further comprises computer code configured to perform the synchronization of the message pursuant to a request sent by a client to the server to synchronize only the message, wherein the message is at least one of stored and received with a plurality of other messages and the request is effectuated using a record level filter.

32. The server apparatus of claim 30, wherein the message is an email message.

33. The server apparatus of claim 30, wherein the first modification data is associated with locally performed modifications at a client, operatively connected to the server, including at least one of a new message, a reply message, and a forward message, a soft message deletion, a hard message deletion, and saving the message at a main message storage located at the server.

34. The server apparatus of claim 30, wherein the second modification data is associated with new information received at the server.

35. A system configured to transmit a message using a data synchronization protocol, comprising:
a client configured to begin a synchronization session and transmit a first data modification; and
a server, operatively connected to the client via a mobile messaging enabler, configured to receive and process the first data modification and send a second data modification to the client; wherein:
the message is synchronized between the client and the server in accordance with at least one of the first and second data modifications, the message being represented as an extensible markup language document conformant to an object, wherein synchronizing the message includes at least one of the group including downloading only at least one of a plurality of particular headers of the message to the client, downloading only a text part of the message to the client, downloading attachment parts of the message singularly to the client, identifying at least one attachment part of the message, downloading one of the text part and the at least one attachment part of the message without downloading any headers to the client, forwarding the message from the client without downloading and uploading the message in its entirety, and performing content adaptation of at least one alternative part of the message upon request by the client.

36. The system of claim 35, wherein the message is an email message.

37. A messaging object, embodied on a computer-readable medium, comprising:
an extensible markup language-formatted document describing a structure containing at least one of a header portion, a table of contents portion, and a body part description portion including at least one of a text part and an attachment part, wherein synchronizing a message represented by the extensible markup language document includes at least one of the group including downloading only at least one of a plurality of particular headers of the message, downloading only a text part of the message, downloading attachment parts of the message singularly, identifying at least one attachment part of the message, downloading one of the text part and the at least one attachment part of the message without downloading any headers, forwarding the message without downloading and uploading the message in its entirety, performing content adaptation of at least one alternative part of the message upon request by a messaging client.

38. The messaging object of claim 37, wherein the message is an email message.
